(19) United States
(12) Patent Application Publication
(10) Pub. No.: US 2026/0030995 A1
(43) Pub. Date: Jan. 29, 2026

(54) REAL-TIME VIRTUAL CHARACTER TUTOR GENERATION AND PRESENTATION INTEGRATED WITH ADAPTIVE LEARNING USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventor: Shawn Sullivan, Seattle, WA (US)

(73) Assignee: 2hr Learning, Inc., Austin, TX (US)

(21) Appl. No.: 19/218,311

(22) Filed: May 25, 2025

Related U.S. Application Data
(60) Provisional application No. 63/651,629, filed on May 24, 2024.

(51) Int. Cl. G09B 7/04

(52) U.S. Cl. CPC G09B 7/04

(57) ABSTRACT

The real-time tutor generation system using Artificial Intelligence for adaptive learning includes an artificial intelligence (AI) engine to generate a virtual character for adaptive and personalized learning experiences. The method involves processors that perform operations such as accessing a virtual character from a library via a user interface integrated within an online learning platform. Communication initialization between the user and the virtual character begins by receiving real-time speech input, converted to text using a speech-to-text converter. A prompt generator generates prompts for the AI engine, based on the user input. The AI engine utilizes a pre-trained Large Language Model (LLM) to match the behavior and speech patterns of specific figures, including historical, fictional, animation, and cartoon characters. The generated audio response is converted into a video featuring the virtual character speaking, enhancing the user's learning experience by integrating video with the selected character.

### FIELD OF THE INVENTION

The present invention relates in general to the field of electronics, and more specifically to the real-time generation of tutors using an artificial intelligence (AI) based adaptive learning system which generates tutors in real-time to provide adaptive and personalized learning to the user.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary real-time tutor generation system using Artificial Intelligence for adaptive learning.

FIG. 2 depicts an exemplary real-time tutor generation process using Artificial Intelligence for adaptive learning.

FIG. 3 depicts an exemplary scenario where a real-time tutor uses multiple sources as inputs to provide adaptive and personalized learning to the user.

FIG. 4 depicts a flow diagram showing details of the steps involved in the real-time tutor generation process using Artificial Intelligence for adaptive learning.

FIG. 5 depicts the sequence diagram for online learning by combining adaptive learning algorithms with the engaging presence of historical personas.

FIG. 6 depicts the sequence diagram for real-time feedback and engagement assessment of the user for measuring dynamic user involvement.

FIG. 7 depicts the sequence diagram to detect cognitive overload and suggest breaks when needed during online sessions.

FIG. 8 depicts the sequence diagram that provides the curriculum progress of the user using an indicator linked to the specific figure.

FIG. 9 depicts a user interface displaying a real-time tutor who helps the user in adaptive and personalized learning.

FIGS. 10 and 11 depict a user interface displaying an exemplary real-time tutor teaching the user a history lesson in an online learning platform.

FIG. 12 depicts a diagram using a data structure for online learning by combining adaptive learning algorithms with the engaging presence of historical personas.

FIG. 13 depicts a diagram using a data structure for real-time feedback and engagement assessment of the user for measuring dynamic user involvement.

FIG. 14 depicts a diagram using a data structure to detect cognitive overload and suggest breaks when needed during online sessions.

FIG. 15 depicts a diagram using a data structure to provide the curriculum progress of the user using an indicator linked to the specific figure.

FIG. 16 depicts an exemplary network environment in which the system of FIG. 1 and the process of FIG. 2 may be practiced.

FIG. 17 depicts an exemplary computer system.

### DETAILED DESCRIPTION

A real-time tutor generation system using Artificial Intelligence (AI) for adaptive learning includes an AI engine that generates a response for the user based on the prompt generated by a communication module. The AI engine displays the generated response to the user on an online learning platform on a user device. The real-time tutor generation system using Artificial Intelligence (AI) for adaptive learning further includes one or more processors that are used for executing codes in a computer system to cause the computer system to operate.

A NLP (Natural Language Processor) is integrated within the communication module and is operatively coupled to the online learning platform. The NLP accesses the virtual character from a virtual characters library having a plurality of virtual characters via a user interface integrated within an online learning platform. A communication initialization module initializes the communication between the user and the virtual character by receiving real-time speech input from the user from a receiver integrated within the communication initialization module. The speech input is received from the user in real-time while initializing communication with the virtual character via a microphone or voice input device in the user's device. The user speech input is converted to text using a speech-to-text converter operatively coupled to the communication module.

A prompt generator integrated within the communication module and operatively coupled to the AI engine generates a prompt to guide the AI engine in providing adaptive and personalized learning to the user. The AI engine uses an AI NLP (Artificial Intelligence Natural Language Processor) to analyze the text input. The AI NLP includes a text-to-speech converter and a response generator. A LLM (Large Language Module), integrated within the communication module and operatively coupled to the prompt generator, is pre-trained and configured to match the behavior and speech patterns of the specific figure, including historical, fictional, animation, and cartoon characters.

The prompt generator transfers the prompt to the AI engine. The guiding prompts transferred to the AI engine are generated by analyzing user input to determine the user's learning needs, preferences, or areas requiring assistance, thereby guiding the AI engine to provide relevant and personalized responses. The video streaming module receives a video of the virtual character speaking the generated audio response generated using the AI engine. The generated video is used for adaptive and personalized learning of the user by integrating the video with the selected virtual character.

The real-time tutor generation system using Artificial Intelligence for adaptive learning offers a range of advantages, making it a significant advancement in virtual conversational agents. By incorporating information from provided sources, the virtual characters deliver accurate and contextually relevant responses, ensuring users receive comprehensive answers to their queries. Additionally, the use of a vector store enables efficient access to knowledge, enhancing the virtual character's ability to retrieve information quickly. The adaptability of the real-time tutor generation system using Artificial Intelligence for adaptive learning allows it to mimic or reproduce specific figures, providing personalized interactions that engage users more effectively. With natural language understanding, the virtual character i.e., a real-time tutor responds in a human-like manner, improving the quality of interactions and engagement level of the user.

Furthermore, the real-time tutor generation system using Artificial Intelligence for adaptive learning offers a rich multimedia experience through the synthesis of audio and video responses. By converting text responses into speech and animating virtual characters to speak the generated audio, users can engage with the virtual character in a more interactive and visually appealing manner. This multimedia approach not only enhances user engagement but also facilitates better comprehension of complex topics.

While the real-time tutor generation system using Artificial Intelligence for adaptive learning presented herein makes use of specific reference to dynamic, adaptive, and personalized learning for the students using a real-time tutor generated by AI (Artificial Intelligence), it is to be appreciated that the description is also equally applicable for school teachers, parents teaching their child at home, the student doing self-tutoring, coaching tutors, adults learning for their career development, employees in corporate training, parents for parenting education, children for craft, music and other education, elderly people for medical guidance, medical staff for guidance and so on.

Similarly, the real-time tutor generation system using Artificial Intelligence for adaptive learning disclosed herein has mentioned the real-time tutor i.e., a virtual character teaching the student as a historical persona. But, the virtual character is not limited to the historical persona i.e., Abraham Lincoln in the present scenario. The virtual character may include another character of the user's choice like cartoon, animations, political, film stars, and so on.

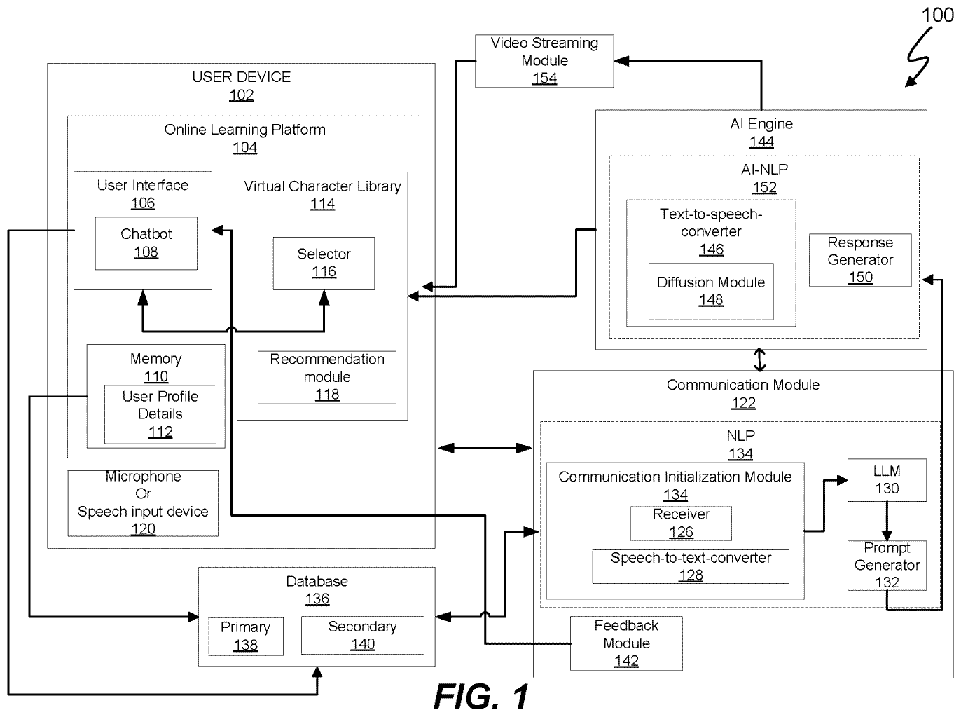

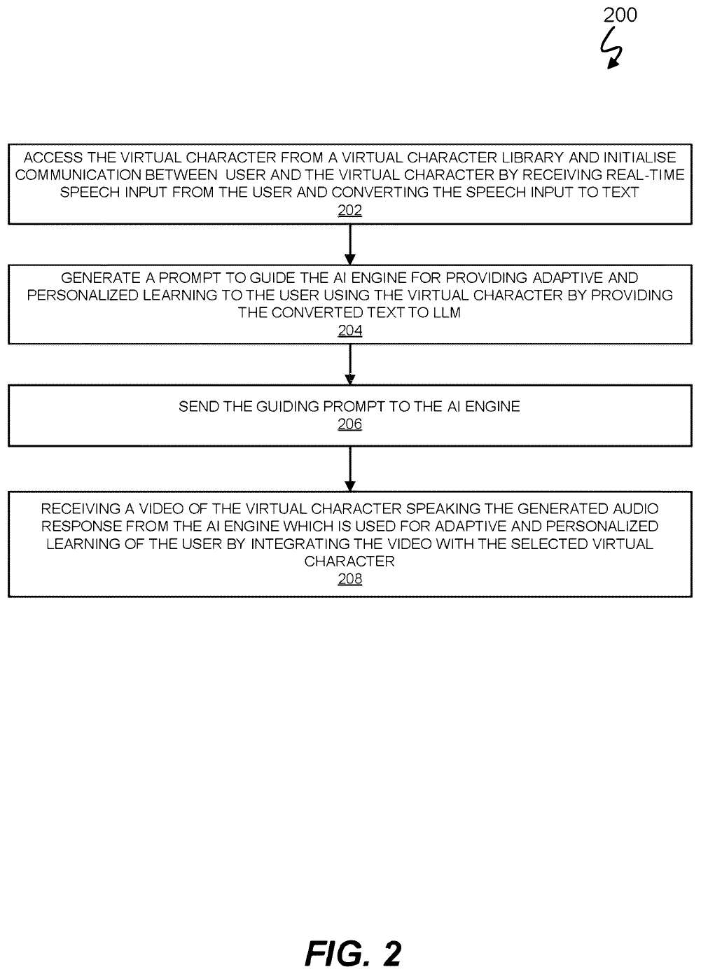

FIG. 1 depicts an exemplary real-time tutor generation system 100 using Artificial Intelligence for adaptive learning. FIG. 2 depicts an exemplary real-time tutor generation process 200 using Artificial Intelligence for adaptive learning utilized by real-time tutor generation system 100.

A real-time tutor generation system 100 using Artificial Intelligence for adaptive learning comprises an AI engine 144 that generates a real-time response to the user based on the interaction of the user with an online learning platform 104, user requirements, and so on. The online learning platform 104 is operatively coupled to the AI engine 144. The online learning platform 104 is accessed by the user through a user device 102. A communication module 122 is operatively coupled to the AI engine 144 and the online learning platform 104 which is configured to initiate the communication process between the user and a virtual character selected by the user. The communication module 122 is further configured to generate a prompt to guide the AI engine 144 for generating responses to adaptive and personalized learning to the user using the online learning platform 104. The real-time tutor generation system 100 using Artificial Intelligence for adaptive learning further comprises one or more databases 136 operatively coupled to one or more processors of a computer system and uses codes to execute the below-mentioned operations.

Referring to FIGS. 1 and 2, in operation 202, the virtual character is accessed from a virtual characters library 114 with a plurality of virtual characters. The communication initialization module 124 initializes the communication between the user and the virtual character by receiving real-time speech input from the user. The user speech input is converted to text using a speech-to-text converter 128. The speech input is received from the user in real-time while initializing communication with the virtual character via a microphone or voice input device 120 in the user's device 102.

The virtual characters are integrated within the online learning platform 104 and are selected by the user based on his/her preferences. For example, a small kid may use cartoon characters as a real-time tutor to guide him in the online learning sessions. Similarly, if a student wishes to learn the US Civil War history, he may choose Abraham Lincoln. The virtual characters offer personalized learning recommendations based on user preferences and learning history.

The user selects the virtual character from the virtual character library 114 by logging in to the online learning platform 104 where the user interface 106 presents various virtual character options, allowing users to choose from a selection based on their preferences. The user interface 106 provides users with a visual representation of the available characters, making it easier for them to make a selection. Additionally, a selector 116 is integrated within the virtual character library 114, enabling users to make their choices from the available virtual characters. This selector 116 further allows users to quickly identify and pick their preferred character. Moreover, the online learning platform 104 includes a recommendation module 118, which utilizes data from the user's learning history, preferences, and current learning tasks to suggest virtual characters. By analyzing this data, the recommendation module 118 offers personalized suggestions, guiding users to virtual characters that align with their educational needs and interests. Together, these components ensure that users have a range of options for selecting virtual characters, enhancing and personalizing the overall learning experience of the user.

The virtual characters are displayed on a user interface 106 of an online learning platform 104 and offer an initial greeting message to the user upon initialization of the communication, the greeting message being contextually relevant to the information provided by the online learning platform 104. The user can interact with the virtual character using a chatbot 108 integrated within the online learning platform 104 if the user has doubts during the online learning session or wishes to provide any feedback on the session.

The communication module 122 has the communication initialization module 124 integrated within it to receive input from the user using a receiver 126. The speech-to-text converter 128 converts the received speech input. The speech input is received from the user in real-time while initializing communication with the virtual character via a microphone or voice input device 120 in the user's device 102.

The speech-to-text converter 128 converts spoken input from users into text format for further processing. The speech-to-text converter 128 employs advanced machine learning algorithms designed to accurately transcribe the spoken input with high precision. These machine learning algorithms are trained on vast amounts of speech data, allowing them to recognize patterns and linguistic nuances present in human speech.

Furthermore, the speech-to-text converter 128 involves natural language processing (NLP) techniques to enhance transcription accuracy. NLP techniques enable the speech-to-text converter 128 to interpret and analyze the transcribed text more intelligently, taking into account factors such as context, syntax, and semantics. By applying NLP techniques, the speech-to-text converter 128 can refine the transcription process, improving accuracy and reducing errors.

The communication initialization module 124 is enhanced to provide context data to the virtual character during interactions with the user. This context data includes important information such as user profile details 112, learning history, and current learning objectives. The user profile details are stored in a memory 110 of the online learning platform 104 which includes user ID, previous and current session details, user interests, and so on. By integrating this context data, the virtual character can improvise its responses and interactions to better suit the individual needs and preferences of each user.

The below pseudo-code represents ‘adaptive learning with historical persona integration’:
#Initialize the adaptive learning system with historical persona data
adaptive_system=initialize_adaptive_system_with_persona(‘Abraham Lincoln’)
#Main tutoring loop
while student.has_remaining_standards( ):
current_standard=adaptive_system.get_next_standard(student) learning_content=adaptive_system.generate_learning_content(current standard)
student_response=student.interact with_content(learning_content)
adaptive_system.update_student_profile(student_response)
if adaptive_system.check_understanding(student_response):
   adaptive_system.advance_to_next_standard(student)

In operation 204, a prompt is generated by a prompt generator 132 to guide the AI engine 144 for providing adaptive and personalized learning to the user using the virtual character by providing the converted text to a LLM 122 for analyzing the text input. The prompt generator 132 is operatively coupled to the AI engine 144 and is integrated into the communication module 122. The LLM 130 is pre-trained and configured to match the behavior and speech patterns of the specific figure, including historical, fictional, animation, and cartoon characters.

The converted text input undergoes analysis using a Large Language module (LLM) 130 to create a suitable prompt for the AI engine 144. Subsequently, the prompt generator 132 generates a prompt to guide the AI engine 144 in providing personalized and adaptive learning responses. The prompt generator 132 uses natural language processing (NLP) techniques to generate the prompt. By using a Natural Language Processor (NLP) 134, integrated within the communication module 122, the prompt generator 132 ensures that the prompt generated is contextually relevant and effectively guides the AI engine 144 in generating responses to the user's needs and preferences. Overall, this multi-step process ensures that the AI engine 144 receives clear and meaningful prompts, facilitating the delivery of personalized and adaptive learning experiences to users.

In operation 206, the prompt generator 132 shares the generated prompt with the AI engine 144. The guiding prompt for the AI engine 144 is generated by analyzing user input to determine the user's learning needs, preferences, or areas requiring assistance, thereby guiding the AI engine 144 to provide relevant and personalized responses.

Once the prompt is generated using a prompt generator 132 and transferred to the AI engine 144, it is converted into an audio format using a text-to-speech converter 146. This ensures that the response can be heard by the user. The text-to-speech converter 146 employs neural network-based techniques to produce natural-sounding speech. These techniques use advanced machine learning algorithms to generate speech that sounds more human-like, enhancing the user experience and making the user interaction with the online learning platform 104 more engaging and natural.

The AI engine 144 generates responses in correspondence to the user's learning style, pace, or level of understanding, thereby adapting the learning experience to the individual needs of the user. The user's progress is linked to specific historical figures throughout an online learning session. This process begins with tracking the user's progress, integrating historical narratives with this progress through a mapping algorithm. Curriculum topics and learning objectives are mapped to corresponding historical events, figures, or concepts, allowing the generation of progress indicators linked to specific figures, events, or concepts to provide contextual relevance to the curriculum. User progress data and historical narratives are then analyzed to identify correlations and connections between curriculum progress and specific figures. Finally, progress indicators and historical narratives are displayed to users, enhancing their understanding and engagement with the material by contextualizing it within historical contexts.

The virtual characters exhibit behavior and speech patterns consistent with their specific figures by matching the behavior of the virtual character. The database 136 stores behavior and speech pattern data for each virtual character, and analyzes user input and responses with the expected behavior and speech patterns of the selected virtual character. By employing these components, the real-time tutor generation system 100 using Artificial Intelligence for adaptive learning ensures that virtual characters accurately reflect the mannerisms and speech of their historical counterparts, enhancing the immersive learning experience for users.

In operation 208, a video of the virtual character speaking the generated audio response is received. The response is generated based on the guiding prompts provided to the AI engine 144 by the prompt generator 132. The generated video is used for adaptive and personalized learning of the user by integrating the video with the selected virtual character.

An Artificial Intelligence Natural Language Processor (AI NLP) 152 is integrated within the AI engine 144 and is configured to generate a response based on the prompts provided by the prompt generator 132. The AI NLP 152 includes a text-to-speech converter 146 and a response generator 150. The text-to-speech converter 146 has a diffusion module 148 integrated within it for audio synthesis which is performed by first receiving the generated response from the pre-trained Large Language Module (LLM). This response, derived from the LLM's analysis of the input text, serves as the basis for generating the synthesized speech.

Secondly, the diffusion module 148 within the text-to-speech converter 146 is employed for audio synthesis. The diffusion module 148 processes the received response and converts it into audio. It operates by modeling the distribution of audio waveforms, allowing for the creation of high-quality speech. Thirdly, the diffusion model 148 is conditioned on linguistic features extracted from the generated response text. Conditioning the diffusion model 148 on these linguistic features ensures that the synthesized speech accurately reflects the nuances of natural human speech.

Lastly, the diffusion model 148 is modulated to control the clarity and naturalness of the synthesized speech. This modulation involves adjusting various parameters of the diffusion model 148 to enhance the quality and realism of the audio output. By controlling factors such as pitch, tone, and pacing, the modulation process helps to produce speech that sounds natural and intelligible. Overall, the diffusion module's 148 sophisticated synthesis process, combined with conditioning and modulation, enables the text-to-speech converter 146 to generate high-quality, lifelike speech output that enhances the user's interaction with the virtual character.

The AI engine 144 is further designed to animate the virtual character's facial expressions and lip-syncing in response to the generated audio. This means that the character's face will move in sync with the speech it produces, enhancing the realism of the interaction. Additionally, the AI engine 144 incorporates visual cues like eye movements and gestures to further enhance the character's realism and make the interaction more engaging for users. These features contribute to a lifelike interaction experience, improving user engagement with the virtual character.

Database 136 includes primary 138 and secondary 140 sources about a specific historical figure to the Large Language Module (LLM) 130 to facilitate context and response generation. The database 136 is operatively coupled to the online learning platform 104 and communication module 122. These sources are crucial for ensuring the accuracy and authenticity of the responses. Primary sources 138 encompass authentic documents, recordings, or artifacts directly associated with the specific figure, while secondary sources 140 include scholarly works, historical accounts, biographies, and analyses related to the figure. By incorporating information from both primary 138 and secondary 140 sources, the real-time tutor generation system 100 using Artificial Intelligence for adaptive learning can generate well-informed and contextually appropriate responses.

The real-time tutor generation system 100 using Artificial Intelligence for adaptive learning uses two different patterns of utilizing the information from the one or more databases 136. The first one describes how information from primary 138 and secondary 140 sources is integrated into a generated response. Initially, keywords and phrases are extracted from the user's input. Then, these keywords and phrases are used to search the primary 138 and secondary 140 resources to gather relevant information. The response is generated by the AI engine 144 with the incorporation of details obtained from these resources. This process ensures that the responses are rich in content and reflect the insights gathered from historical materials.

The second method involves the steps for reviewing and refining a generated response using information from primary 138 and secondary 140 resources. First, an initial response is generated by the AI engine 144 without reference to the primary 138 and secondary 140 sources. Then, this initial response is reviewed in correspondence with the primary 138 and secondary 140 resources to ensure consistency and accuracy. Specific keywords and phrases from the initial response are identified to create search terms for retrieving relevant information from the resources. The primary 138 and secondary 140 resources are then searched using these terms to gather additional information. Finally, the initial response is modified by incorporating the retrieved information to ensure accuracy and consistency, thereby refining the response iteratively. This process guarantees that the responses provided are thoroughly reviewed and enhanced with information from credible historical sources.

The video streaming module 154, plays a crucial role in the adaptive and personalized learning process. The video streaming module 154 is operatively coupled to the AI engine 144. The video streaming module 154 receives the generated response from the response generator 150 of the AI engine 144. The video streaming module 154 streams real-time video responses from the virtual character directly onto the user interface 106 of the online learning platform 104. This means that when the virtual character responds, whether it's explaining a concept or topic, offering guidance, or answering a question, the user sees this response as a video in real-time. This visual interaction not only enhances engagement but also facilitates immediate feedback from the user using the feedback module 142. The feedback module 142 allows users to respond directly to the virtual character's video, whether through clicks, comments, or other forms of interaction. This immediate feedback loop is invaluable as it helps to improve the learning experience for the user in real-time. For instance, if a user expresses confusion, the virtual character can adapt its response accordingly, providing further clarification or additional resources.

The below pseudo-code represents the ‘adaptive learning algorithms with Historial Persona integration’
#Import necessary libraries
import adaptive_learning_system as als
import historical_persona as hp
#Initialize the adaptive learning system with a historical persona
adaptive_tutor=als.AdaptiveLearningSystem(persona=hp.AbrahamLincoln( ))
#Main loop for the tutoring session
while not student.finished_course( ):
   #Assess the student's current knowledge state
   knowledge_state=adaptive_tutor.assess_knowledge (student)
   #Generate content based on the student's knowledge state and historical persona
   content=adaptive_tutor.generate_content (knowledge_state)
   #Present the content to the student adaptive_tutor.present_content (content, student) #Receive student's response and update knowledge state
   student_response=student.provide_response( )
   adaptive_tutor.update_knowledge_state (knowledge_state, student_response)
   #Check for engagement and understanding, provide feedback
   engagement_level=
   adaptive_tutor. assess_engagement (student_response)
   adaptive_tutor.provide_feedback (engagement_level, student) #If the student is ready, move to the next learning unit
   if adaptive_tutor.is_ready_for_next_unit (knowledge_state): adaptive_tutor.advance_to_next_unit (student)
#Comments:
#The adaptive learning system is initialized with a historical persona, in this case, Abraham Lincoln.
#The system assesses the student's knowledge and generates content that is both adaptive to their learning needs and infused with the historical persona's context.
#The student interacts with the system, providing responses that the system uses to update the student's knowledge state.
#The system assesses the student's engagement level and provides feedback accordingly.
#The system advances the student to the next learning unit when they are ready.

The data structure for ‘the real-time tutor generation system 100 using Artificial Intelligence for adaptive learning’ is given below:
class StudentProfile:
   def init_(self,name);
      self.name=name
      self.performance metrics={ }
      self.learning_style={ }
class HistoricalPersona:
   def_init (self,name):
      self.name=name
      self.life experiences=[ ]
      self.opinions=[ ]
class AdaptiveLearningSystem:
   def_init_(self,persona);
      self.student_profile=StudentProfile( )
      self.historical persona=HistoricalPersona (persona)
      self. learning_progress={ }
   def assess_knowledge (self, student); #Assess knowledge state
   pass
   def generate_content (self, knowledge_state); #Generate personalized content pass
   def present_content (self, content, student);
#Present content to student pass
   def update_knowledge_state (self, knowledge_state, student_response);
#Update knowledge state based on student response
   pass
   def assess_engagement (self, student_response);
#Assess student engagement pass
   def provide_feedback (self, engagement_level, student): #Provide feedback to student pass
   def is ready_for_next_unit (self, knowledge state): #Check if student is ready for next unit pass
   def advance_to_next_unit (self, student): #Advance student to next unit pass

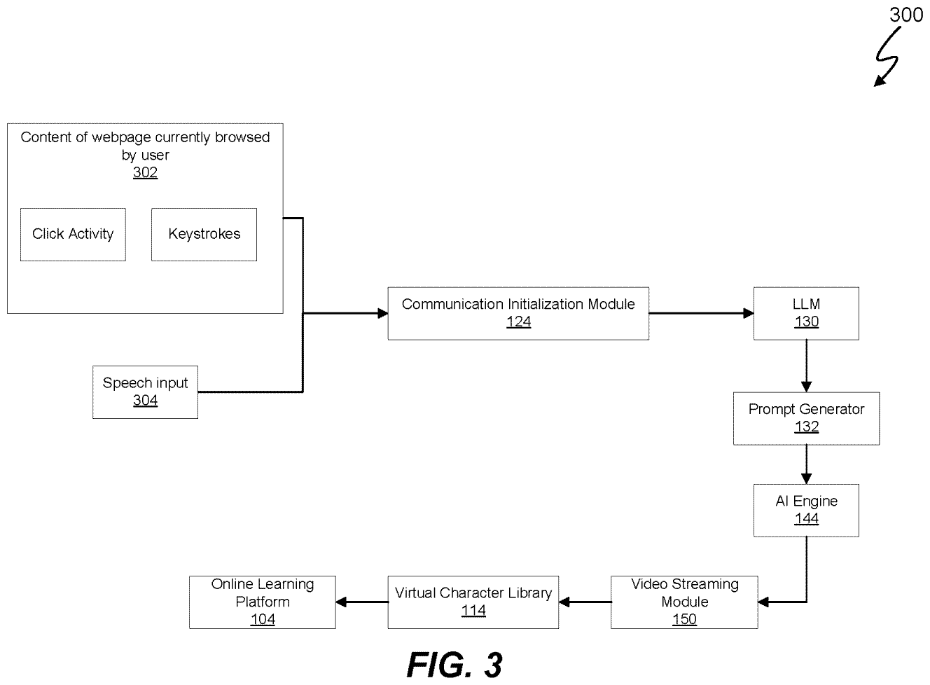

In another embodiment, the real-time tutor generation system 100 using Artificial Intelligence for adaptive learning involves receiving and analyzing context data of a user's browsing activity, including the content of web pages, click activity and keystrokes. This data is then passed to an AI engine 144 to generate a response corresponding to the user's browsing context. The generated response is delivered to the user through a virtual character, providing assistance or answers related to the content being browsed. This approach enables dynamic and personalized interaction with users, enhancing their browsing experience and facilitating access to relevant information. This methodology is explained in detail below in FIG. 3.

In yet another embodiment, the real-time tutor generation system 100 using Artificial Intelligence for adaptive learning suggests breaks between sessions triggered by cognitive load detection by monitoring user performance and behavior, including eye movements and facial expressions, to gauge cognitive load and stress. Based on this, the cognitive load and stress levels are detected using algorithms and biometric sensors. The performance metrics of the user are analyzed to assess cognitive load by scheduling breaks based on detected levels to optimize learning efficiency and well-being, with adjustable frequency and duration and notifying users through auditory and visual cues. Meanwhile, the emotions in user are recognized by analyzing facial expressions and tone.

FIG. 3 depicts an exemplary scenario where a real-time tutor uses multiple sources as inputs to provide adaptive and personalized learning to the user.

In the real-time tutor generation system 100 using Artificial Intelligence for adaptive learning, method 300 begins by receiving real-time input from the user, which can originate from various sources. Firstly, it includes capturing the content of the webpage currently being browsed by the user 302. This includes not only the textual content of the webpage but also the user's click activity and keystrokes, providing a comprehensive understanding of the user's browsing context. Additionally, input from the user in the form of speech 304 is received from the microphone or any speech input device available on the user's device 102.

Once the real-time input is collected, it is passed to a Large Language Model (LLM) 130 which is integrated into the communication initialization module 124. Simultaneously, the speech input is converted to text using a speech-to-text converter 128 and passed to the same LLM 130 which analyzes both the inputs and generates a prompt, which is sent to the AI engine 144 for further processing.

The AI engine 144, equipped with AI Natural Language Processing (NLP) capabilities, utilizes the received prompts from the prompt generator 132, operatively coupled to the LLM 130 to generate a response in correspondence to the content of the webpage 302 being viewed by the user and their speech input 304. The AI NLP 152 converts the generated text into speech using diffusion module 148 for audio synthesis. Subsequently, the response generator 150 finalizes the response.

The generated response is then delivered to the user using a video streaming module 154, providing assistance or answering questions related to the content being browsed by the user. This video streaming module 154 is connected to the virtual character library 114, and the response is directed to the virtual character selected by the user. The generated video, with the virtual character speaking the response, is displayed to the user on the user interface 106 of the online learning platform 104.

The real-time tutor generation system 100 using Artificial Intelligence for adaptive learning ensures that users receive personalized and contextually relevant responses to their queries or interactions, incorporating both textual and speech input.

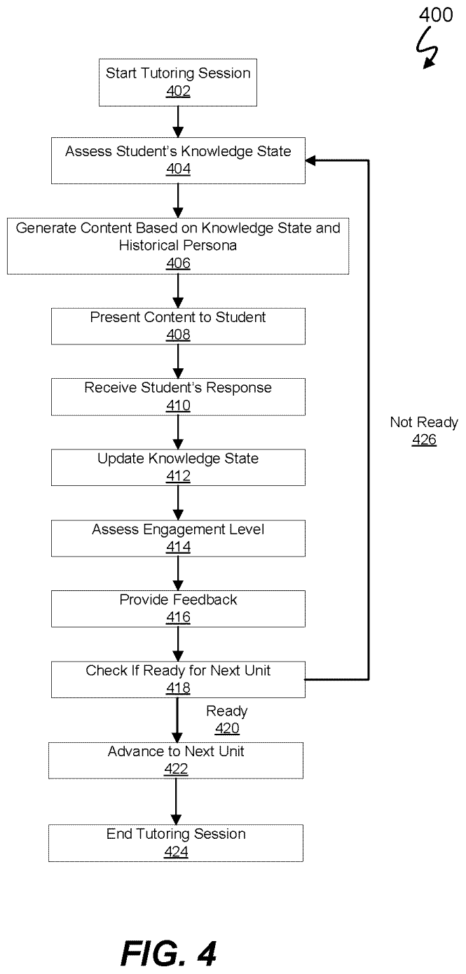

FIG. 4 depicts a flow diagram 400 showing details of the steps involved in the real-time tutor generation process 200 using Artificial Intelligence for adaptive learning.

The flow diagram 400 discloses the method of guiding an artificial intelligence (AI) engine to generate a real-time tutor i.e., a virtual character for providing adaptive and personalized learning to a user. The process begins with initiating online learning sessions 402 on an online learning platform 104. Here, the virtual character is chosen from a virtual characters library 114 which is integrated within the online learning platform 104. The user selects the virtual character based on his/her choice and the topic which the user wishes to learn. For example, if the user wishes to learn a history lesson related to the US Civil War, then he might select Abraham Lincoln as a real-time tutor for himself. The user can interact with the virtual character using a chatbot 108 integrated into the online learning platform 104. The virtual character serves as a real-time tutor, providing personalized and adaptive learning experiences to the user. During these online learning sessions, the real-time tutor generation system 100 using Artificial Intelligence for adaptive learning assesses the student's knowledge state 404 through various means such as user profiles, quizzes, and chat interactions. Based on this assessment, the AI engine 144 generates response 406 in correspondence to the student's knowledge level and historical persona, which is selected by the user according to their interests. The generated response is then displayed 408 on the online learning platform 104 of the user's device 102.

As the student engages with the generated response, the student can interact with the real-time tutor410, if they have any doubts about the streamed video response or they wish to share any feedback on the video generated using the chatbot 108. The real-time tutor generation system 100 using Artificial Intelligence for adaptive learning updates the student's knowledge state 412 based on the feedback received from these interactions, as well as from quizzes and further chat interactions. Additionally, the AI engine 144 assesses the student's engagement level 414 throughout the session, and based on this, the AI engine 144 generates an updated and modified version of the generated response for the user. For example, if the user is not able to understand what the real-time tutor is teaching in the generated response then the user can provide feedback that he is not able to understand the topic. Based on the provided feedback, the AI engine 144 will regenerate the response and provide it to the user.

Based on the student's progress and engagement, the real-time tutor generation system 100 using Artificial Intelligence for adaptive learning provides feedback 416 and determines if the student is ready 418 to advance to the next unit of the curriculum or the next level of that topic. If the student is ready 420, the real-time tutor generation system 100 using Artificial Intelligence for adaptive learning proceeds to the next tutoring session 422, which includes the next chapter of the curriculum or the next level of the current topic. After each session, the real-time tutor generation system 100 using Artificial Intelligence for adaptive learning ends the online learning session 424.

If the student is not ready to progress, the real-time tutor generation system 100 using Artificial Intelligence for adaptive learning reassesses the student's knowledge state and repeats the process 426 until the student is prepared to move forward and attain mastery in that particular topic. Throughout this process, the real-time tutor generation system 100 using Artificial Intelligence for adaptive learning dynamically provides the learning experience to the individual student's needs, preferences, and learning pace, providing a truly personalized and adaptive learning environment.

The data structure of the given flow diagram 400 is disclosed below:

```
  digraph G {
    node [shape=box];
    start [label=“Start Tutoring Session”];
    assess_knowledge [label=“Assess Student's Knowledge State”];
    generate_content [label=“Generate Content Based on Knowledge
State and Historical Persona”];
    present_content [label=“Present Content to Student”];
    receive_response [label=“Receive Student's Response”];
    update_knowledge [label=“Update Knowledge State”];
    assess_engagement [label=“Assess Engagement Level”];
    provide_feedback [label=“Provide Feedback”];
    check_readiness [label=“Check if Ready for Next Unit”];
    advance_unit [label=“Advance to Next Unit”];
    end [label=“End Tutoring Session”];
    start -> assess knowledge;
    assess_knowledge -> generate_content;
    generate_content -> present_content;
    present_content -> receive_response;
    receive_response -> update_knowledge;
    update_knowledge -> assess_engagement;
    assess_engagement -> provide_feedback;
    provide_feedback -> check_readiness;
    check_readiness -> advance_unit [label=“Ready”];
    check_readiness -> assess_knowledge [label=“Not Ready”];
    advance_unit -> end;
  }
```

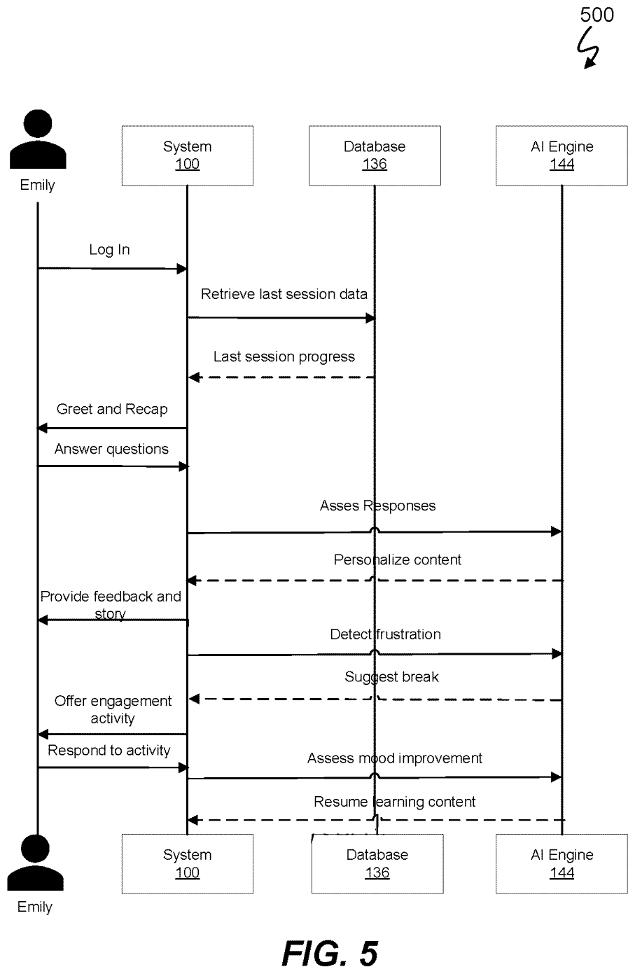

FIG. 5 depicts the sequence diagram 500 for online learning by combining adaptive learning algorithms with the engaging presence of historical personas.

The real-time tutor generation system 100 using Artificial Intelligence for adaptive learning introduces a unique approach to adaptive learning by incorporating a historical persona into the educational experience to enhance engagement and personalization. The exemplary scenario is shown by integrating the historical persona. Although, the real-time tutor can be any other virtual character as well. By integrating interactive elements related to the life and opinions of historical figures like Abraham Lincoln, the real-time tutor generation system 100 using Artificial Intelligence for adaptive learning offers a more immersive and memorable learning environment. This allows a personalized and adaptive learning experience along with an increased engagement level of the user.

The real-time tutor generation system 100 using Artificial Intelligence for adaptive learning operates by collecting real-time inputs such as student responses, performance metrics, and interaction data. These inputs are derived from the student's interactions, historical databases, and educational content repositories. Using AI NLP processing techniques, the AI engine 144 analyzes these inputs to generate personalized learning content, provide feedback, and offer engagement activities.

The sequence diagram 500 illustrates an exemplary scenario where the interaction between Emily (the student), the real-time tutor generation system 100 using Artificial Intelligence for adaptive learning, the database 136, and the AI engine 144 during an online learning session in an online learning platform 104 is disclosed. Emily initiates the session by logging into the real-time tutor generation system 100 using Artificial Intelligence for adaptive learning using her device 102. Upon receiving her login request, the real-time tutor generation system 100 using Artificial Intelligence for adaptive learning retrieves data from database 136 regarding Emily's last session, including her progress. Once retrieved, database 136 sends the last session progress data back to the real-time tutor generation system 100 using Artificial Intelligence for adaptive learning.

The real-time tutor generation system 100 using Artificial Intelligence for adaptive learning then greets Emily and recaps her previous session. Emily proceeded to answer questions presented to her and designed to assess her understanding of the material. Emily is learning about the Civil War using the online learning platform 104. As she answers questions about the Battle of Gettysburg, the virtual character i.e., her real-time tutor, embodied as Lincoln, provides feedback and shares anecdotes related to her answers. After Emily answers the questions, the real-time tutor generation system 100 using Artificial Intelligence for adaptive learning sends her responses to the AI engine 144 for assessment. The AI engine 144 analyzes Emily's responses and personalizes the content based on her answers.

Subsequently, the real-time tutor generation system 100 using Artificial Intelligence for adaptive learning provides feedback to Emily on her responses and shares a relevant story to enhance engagement. During this interaction, the system monitors Emily's behavior for signs of frustration. If frustration is detected, the real-time tutor generation system 100 using Artificial Intelligence for adaptive learning sends a signal to the AI engine and suggests a break.

Upon receiving the suggestion, the real-time tutor generation system 100 using Artificial Intelligence for adaptive learning offers Emily an engagement activity to help alleviate her frustration. Emily responds to the activity, and the real-time tutor generation system 100 using Artificial Intelligence for adaptive learning assesses any improvement in her mood. Once the break is completed, Emily resumes her learning content.

The data structure for the sequence diagram 500 for online learning by combining adaptive learning algorithms with the engaging presence of historical personas is given below:
participant E as Emily
participant S as System
participant DB as Database participant AI as AI Engine
E->>S: Log in
S->>DB: Retrieve last session data
DB-->>S: Last session progress
S->>E: Greet and recap
E->>S: Answer questions
S->>AI: Assess responses
AI-->>S: Personalize content
S->>E: Provide feedback and story
S->>AI: Detect frustration
AI-->>S: Suggest break
S->>E: Offer engagement activity
E->>S: Respond to activity
S->>AI: Assess mood improvement
AI-->>S: Resume learning content

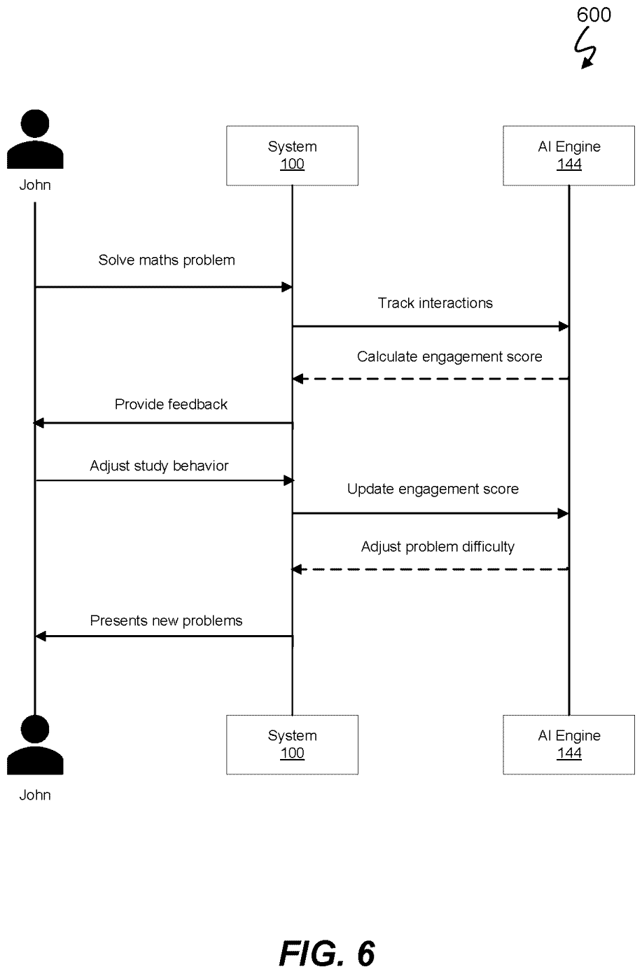

FIG. 6 depicts the sequence diagram 600 for real-time feedback and engagement assessment of the user for measuring dynamic user involvement.

The real-time tutor generation system 100 using Artificial Intelligence for adaptive learning enhances student engagement through real-time feedback and assessment by quantifying student engagement levels in real-time, providing dynamic feedback based on the intensity of interaction and responsiveness, thus offering a comprehensive measure of student involvement in the learning process.

To achieve this, the real-time tutor generation system 100 using Artificial Intelligence for adaptive learning utilizes inputs such as student interaction data, response times, and behavioral cues, which are collected from user interface interactions, keyboard/mouse usage, and potentially biometric sensors. These inputs are processed to generate engagement scores and personalized feedback messages tailored to each student's interaction patterns.

The sequence diagram 600 illustrates an exemplary scenario where a student named John uses the real-time tutor generation system 100 using Artificial Intelligence for adaptive learning to practice math problems. As John works through the problems, the real-time tutor generation system 100 using Artificial Intelligence for adaptive learning tracks his interactions and provides instant feedback on his engagement level. For instance, if John solves problems quickly and accurately, he receives scores and messages encouraging him to stay focused. Conversely, if his engagement level drops, he may receive suggestions to take a break.

In this sequence diagram 600, John initiates an interaction with the real-time tutor generation system 100 using Artificial Intelligence for adaptive learning by solving math problems. He sends this request to the real-time tutor generation system 100 using Artificial Intelligence for adaptive learning and upon receiving John's request, the real-time tutor generation system 100 using Artificial Intelligence for adaptive learning begins tracking his interactions and then passes this information to the AI engine 144, which calculates an engagement score based on John's interactions. This score represents how engaged John is in solving the math problems.

After calculating the engagement score, the AI engine 144 sends it back to the real-time tutor generation system 100 using Artificial Intelligence for adaptive learning which further uses this score to provide feedback to John, helping him understand his level of engagement. John receives this feedback from the real-time tutor generation system 100 using Artificial Intelligence for adaptive learning and adjusts his study behavior accordingly, based on the suggestions provided. Once John adjusts his study behavior, the real-time tutor generation system 100 using Artificial Intelligence for adaptive learning updates the engagement score and sends it back to the AI engine 144 which is now armed with updated engagement information. The AI engine 144 adjusts the difficulty of the math problems accordingly and ensures that the problems presented to John are appropriately challenging based on his level of engagement and understanding.

Finally, the real-time tutor generation system 100 using Artificial Intelligence for adaptive learning presents new math problems to John, taking into account the adjustments made based on his engagement level. This sequence of interactions demonstrates how the real-time tutor generation system 100 using Artificial Intelligence for adaptive learning dynamically adapts to John's engagement, providing personalized feedback and adjusting the difficulty of the problems to optimize his learning experience.

The sequence diagram 600 for real-time feedback and engagement assessment of the user for measuring dynamic user involvement is given below:
sequenceDiagram
   participant J as John
   participant S as System
   participant AI as AI Engine
   J->>S: Solve math problems
   S->>AI: Track interactions
   AI-->>S: Calculate engagement score
   S->>J: Provide feedback
   J->>S: Adjust study behavior
   S->>AI: Update engagement score
   AI-->>S: Adjust problem difficulty
   S->>J: Present new problems

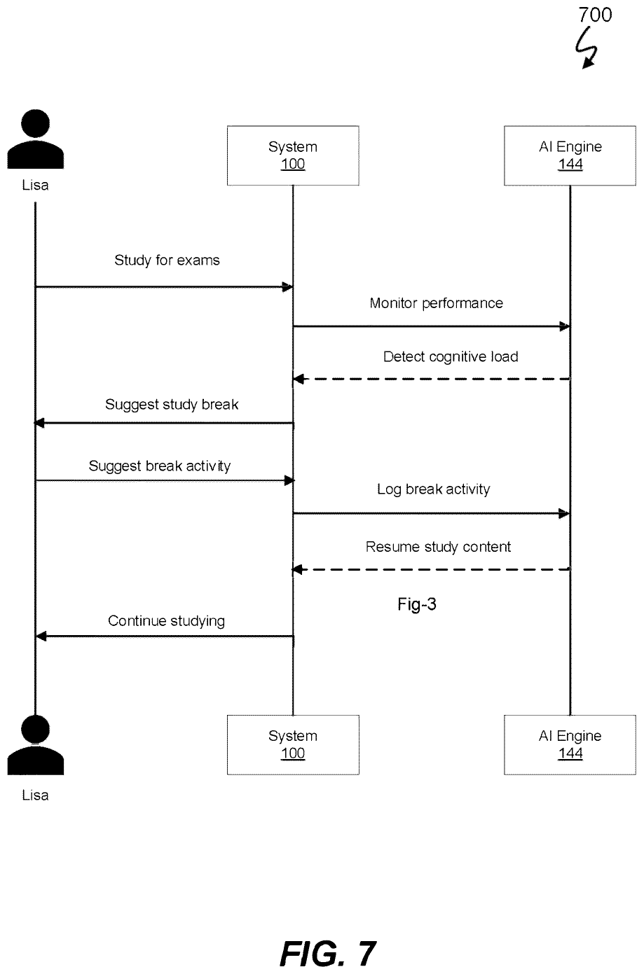

FIG. 7 depicts the sequence diagram 700 to detect cognitive overload and suggest breaks when needed during online sessions.

The real-time tutor generation system 100 using Artificial Intelligence for adaptive learning enhances student's learning experience by detecting signs of cognitive overload and suggesting study breaks with mood-elevating activities. This proactive approach aims to effectively manage cognitive load, ensuring students maintain optimal mental well-being during the online learning session of the students.

To achieve this, the real-time tutor generation system 100 using Artificial Intelligence for adaptive learning utilizes inputs such as student performance data and behavioral indicators of stress or frustration, which are gathered from interactions on the online learning platform 104 and potentially from biometric sensors. These inputs are processed to generate study break suggestions and engagement activities tailored to each student's needs.

The sequence diagram 700 illustrates an exemplary scenario where a student named Lisa is using the real-time tutor generation system 100 using Artificial Intelligence for adaptive learning to prepare for her exams. As Lisa engages with her study material, the real-time tutor generation system 100 using Artificial Intelligence for adaptive learning monitors her cognitive load and suggests breaks when necessary. For example, if Lisa has been studying for an extended period, she receives a suggestion for a break and can choose an activity from the options provided.

In sequence diagram 700, Lisa starts studying for her exams by interacting with the real-time tutor generation system 100 using Artificial Intelligence for adaptive learning by sending a request. Upon receiving Lisa's request, the real-time tutor generation system 100 using Artificial Intelligence for adaptive learning starts monitoring her performance. This performance data is then passed to the AI engine 144, which analyzes Lisa's performance to detect signs of cognitive load.

Once the AI engine 144 detects cognitive load in Lisa's performance, it sends this information back to the real-time tutor generation system 100 using Artificial Intelligence for adaptive learning which suggests a study break for Lisa. Lisa receives the suggestion from the real-time tutor generation system 100 using Artificial Intelligence for adaptive learning and selects a break activity from the options provided.

After Lisa selects a break activity, the real-time tutor generation system 100 using Artificial Intelligence for adaptive learning logs this activity and sends the information to the AI engine 144 which acknowledges the break activity and sends a signal back to the real-time tutor generation system 100 using Artificial Intelligence for adaptive learning to resume the study content. Lisa then continues studying, and the real-time tutor generation system 100 using Artificial Intelligence for adaptive learning provides her with the study material to resume her exam preparation. This sequence of interactions demonstrates how the real-time tutor generation system 100 using Artificial Intelligence for adaptive learning detects cognitive load in Lisa's studying, suggests a break, allows Lisa to choose a break activity, and then resumes the study session, all while monitoring Lisa's performance and adjusting accordingly to optimize her learning experience.

The sequence diagram 700 to detect cognitive overload and suggest breaks when needed during online sessions is given below:
sequenceDiagram
   participant L as Lisa
   participant S as System
   participant AI as AI Engine
   L->>S: Study for exams
   S->>AI: Monitor performance
   AI-->>S: Detect cognitive load
   S->>L: Suggest study break
   L->>S: Select break activity
   S->>AI: Log break activity
   AI-->>S: Resume study content
   S->>L: Continue studying

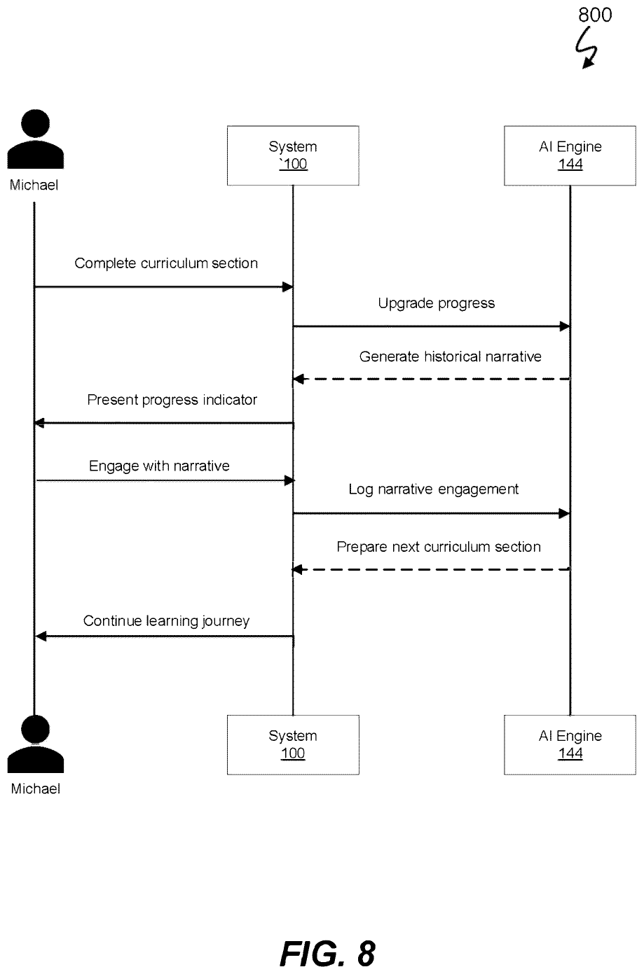

FIG. 8 depicts the sequence diagram 800 which provides the curriculum progress of the user using an indicator linked to the specific figure.

The real-time tutor generation system 100 using Artificial Intelligence for adaptive learning tracks the curriculum progress of the student by linking it to the narrative of historical figures, thereby enhancing the student's sense of achievement and engagement.

To achieve this, the real-time tutor generation system 100 using Artificial Intelligence for adaptive learning collects inputs such as student curriculum progress data and historical narratives from learning management systems and historical content databases. These inputs are processed to generate progress indicators and historical context messages, aligning with the student's learning progress and historical events.

The sequence diagram 800 illustrates an exemplary scenario where a student named Michael is studying the American Revolution. As he completes each section of his curriculum, the real-time tutor generation system 100 using Artificial Intelligence for adaptive learning updates his progress and relates it to the life and achievements of George Washington, a prominent figure of that period. For example, when Michael finishes a section on the Declaration of Independence, he receives a progress update framed within the context of Washington's leadership during that time.

In sequence diagram 800, Michael initiates the process by completing a section of the curriculum, which he sends as a request to the real-time tutor generation system 100 using

Artificial Intelligence for adaptive learning. Upon receiving Michael's completion notification, the real-time tutor generation system 100 using Artificial Intelligence for adaptive learning updates his progress and forwards this information to the AI engine 144, which generates a historical narrative linked to Michael's progress.

Once the historical narrative is generated, the real-time tutor generation system 100 using Artificial Intelligence for adaptive learning presents Michael with a progress indicator, indicating his advancement in the curriculum. Michael engages with the historical narrative which is then logged by the real-time tutor generation system 100 using Artificial Intelligence for adaptive learning to track his engagement. After Michael's engagement is recorded, the AI engine 144 prepares the next section of the curriculum based on his progress.

Finally, the real-time tutor generation system 100 using Artificial Intelligence for adaptive learning continues Michael's learning journey by presenting him with the next section of the curriculum. This sequence of interactions demonstrates how the real-time tutor generation system 100 using Artificial Intelligence for adaptive learning updates Michael's progress, generates a historical narrative, presents progress indicators, logs engagement, and prepares subsequent curriculum sections, all to provide a personalized and engaging learning experience tailored to Michael's progress and interests.

The sequence diagram 800 which provides the curriculum progress of the user using an indicator linked to the specific figure is given below:
sequenceDiagram
   participant M as Michael
   participant S as System
   participant AI as AI Engine
   M->>S: Complete curriculum section
   S->>AI: Update progress
   AI-->>S: Generate historical narrative
   S->>M: Present progress indicator
   M->>S: Engage with narrative
   S->>AI: Log narrative engagement
   AI-->>S: Prepare next curriculum section
   S->>M: Continue learning journey

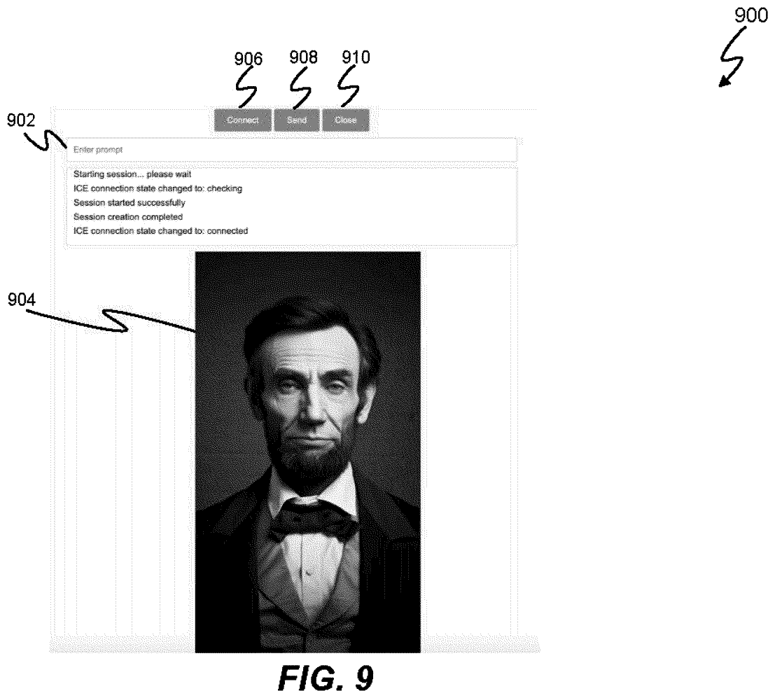

FIG. 9 depicts a user interface 900 displaying the real-time tutor 904 who helps the user in adaptive and personalized learning.

The user interface 900 is accessed by the user through the online learning platform 104 present in the user's device 102 which is operatively coupled to the communication module 122. The user interface 900 includes tab 902 ‘Enter Prompt’ where the user enters the topic which they wish to learn. For example, in the present scenario, the real-time tutor 904 generated is ‘Abraham Lincoln’, so the user may ask the real-time tutor 904 questions related to the US Civil War, the life experience and political career of Abraham Lincoln, and so on.

Tab 906 ‘Connect’ allows users to connect with the real-time tutor 904 which is integrated within the online learning platform 104. Further tab 908 ‘Send’ allows the user to send the topic to the AI engine 144 to generate the video based on the demanded topic by the user. Finally, the user can click on tab 910 ‘Close’ to stop the real-time video streaming on the user interface 900 of the online learning platform 104.

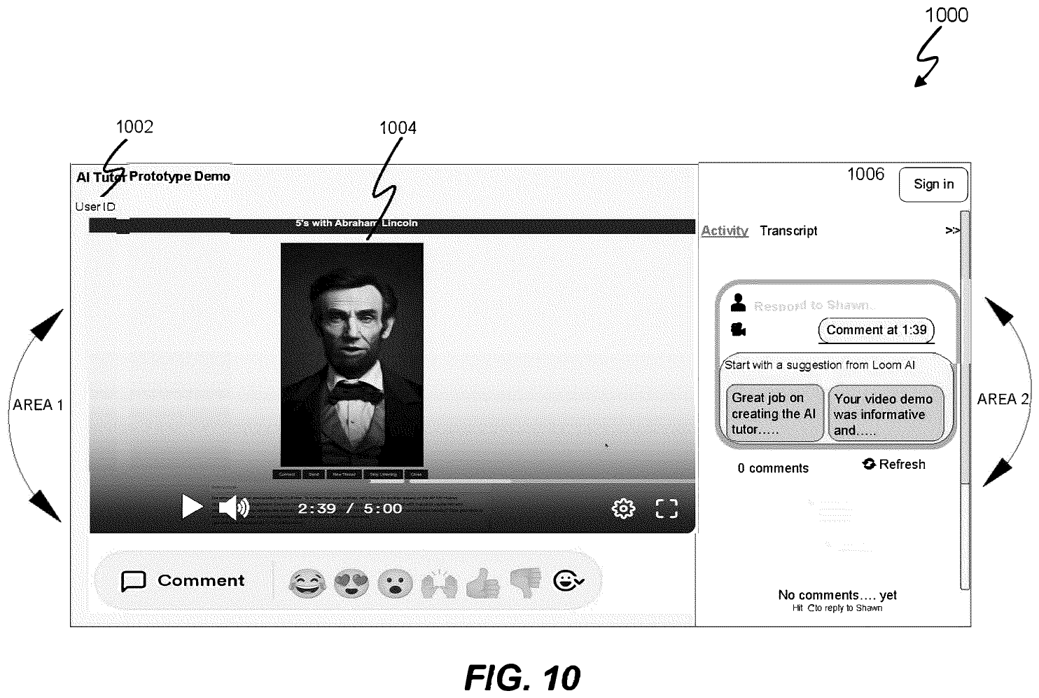

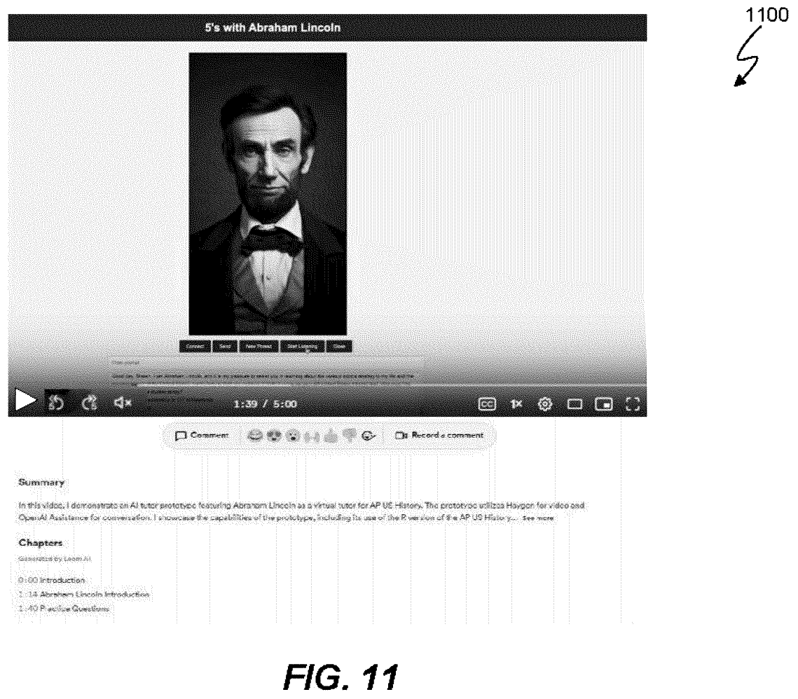

FIGS. 10 and 11 depict a user interface 1000 displaying the exemplary real-time tutor teaching the user a history lesson in an online learning platform 104.

The user interface 1000 is accessed by the user through the online learning platform 104 present in the user's device 102 which is operatively coupled to the communication module 122. Tab 1002 discloses the ‘User Name’ who is using the online learning platform 104 to have adaptive and personalized learning using a real-time tutor 1004, which is ‘Abraham Lincoln’ in the case of the present example. Tab 1006 allows users to ‘Sign in’ to the online learning platform 104. Area 1 shows the ‘video streaming’ part of the online learning platform 104 where the real-time tutor 1004 teaches the user either about the topic selected by the user or the topic selected by the AI engine 144 which is in context to the user profile details 112 stored in the memory 110 of the user device 102. Further, the user can rewind and fast-forward the video using the tabs given in Area 1. Also, the user can increase the speed of the streamed video using the given tab. The user can also provide comments on the real-time generated video which can be either in the form of text, emoji, or video format.

Area 2 shows the activities happening during the online learning session while the real-time tutor 1004 provides personalized and adaptive learning to the user. The chat interaction between the user and the real-time tutor 1004 through the chatbot 108 which is integrated within the online learning platform 104 is displayed here. The user can interact with the real-time tutor 1004 and also provide feedback on the streamed video so that the AI engine 144 can improvise the generated response.

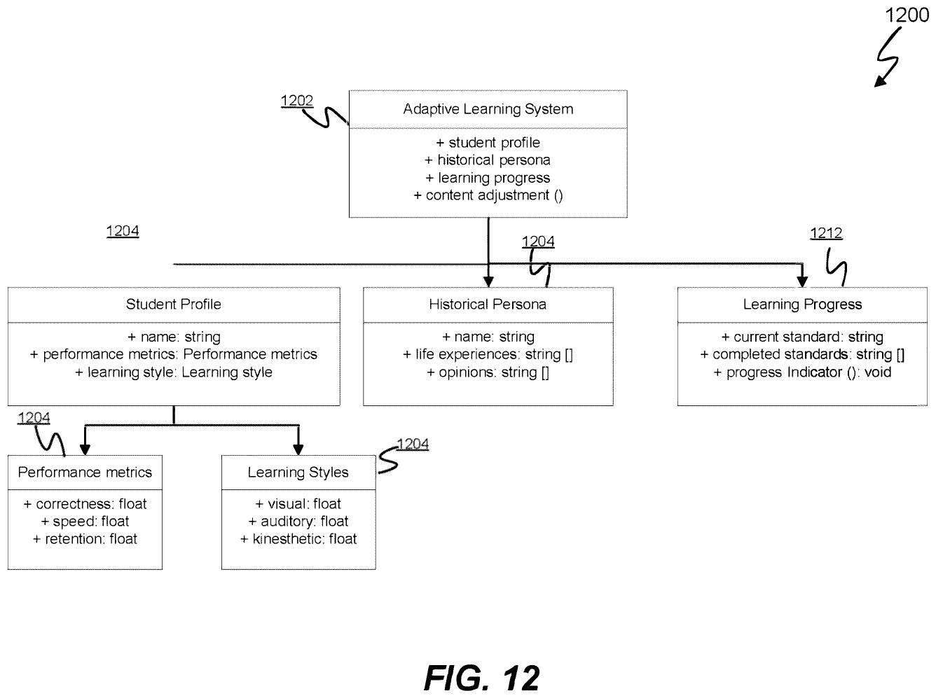

FIG. 12 depicts a diagram 1200 using a data structure for online learning by combining adaptive learning algorithms with the engaging presence of historical personas.

The diagram 1200 represents an Adaptive Learning System 1202 which is designed to personalize learning experiences for students based on the student profiles, historical personas, and learning progress. The Adaptive Learning System 1202 of Diagram 1200 comprises five main components: Student Profile 1204, Historical Persona 1206, Performance Metrics 1208, Learning Style 1210, and Learning Progress 1212.

The Student Profile 1204 component stores essential information about the student, including the name, performance metrics, and learning style preferences of the student. The performance metrics include measures such as correctness, speed, and retention, which are crucial for evaluating the student's learning progress and adapting the content accordingly. Additionally, the learning style preferences indicate whether the student learns best through visual, auditory, or kinesthetic methods. The Historical Persona 1206 component represents a historical persona associated with the student. The historical persona includes details such as the persona's name, life experiences, and opinions. These historical personas provide additional context for understanding the student's background and preferences, helping to improve learning content for student's interests and needs.

The Learning Progress 1212 component tracks the student's progress throughout the learning journey. The Learning Progress 1212 includes fields for the current standard being studied, a list of completed standards, and a method to update progress indicators. This information allows the real-time tutor generation system 100 using Artificial Intelligence for adaptive learning to adapt the learning content dynamically based on the student's progress and achievements. The Adaptive Learning System 1202 interacts with the Student Profile 1204, Historical Persona 1206, and Learning Progress 1212 components to gather relevant information about the student's profile, background, and progress. The Student Profile 1204 component, in turn, connects to both Performance Metrics 1208 and Learning Style 1210 to provide detailed insights into the student's learning capabilities and preferences.

The below data structure prepares the Diagram 1200 for online learning by combining adaptive learning algorithms with the engaging presence of historical personas:

```
  ‘‘‘dot
  digraph G {
    node [shape=record];
    AdaptiveLearningSystem [label=″{Adaptive Learning
System|+ studentProfile\n+ historicalPersona\n+
learningProgress\n+ contentAdjustment( )}″];
    StudentProfile [label=″{Student Profile|+ name:
string\n+ performanceMetrics: PerformanceMetrics\n+
learningStyle: LearningStyle}″];
    HistoricalPersona [label=″{Historical Persona|+ name:
string\n+ lifeExperiences: string[ ]\n+ opinions: string[ ]}″];
    PerformanceMetrics [label=″{Performance Metrics|+
correctness: float\n+ speed: float\n+ retention: float}″];
    LearningStyle [label=″{Learning Style|+ visual:
float\n+ auditory: float\n+ kinesthetic: float}″];
    LearningProgress [label=″{Learning Progress|+
currentStandard: string\n+ completedStandards: string[ ]\n+
progressIndicator( ): void}″];
    AdaptiveLearningSystem -> StudentProfile;
    AdaptiveLearningSystem -> HistoricalPersona;
    StudentProfile -> PerformanceMetrics;
    StudentProfile -> LearningStyle;
    AdaptiveLearningSystem -> LearningProgress;
  }
```

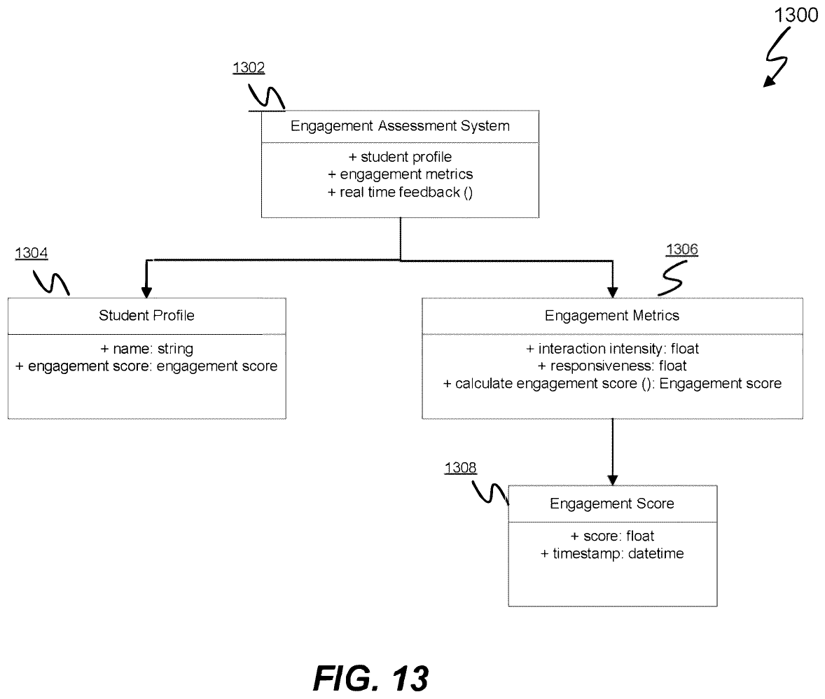

FIG. 13 depicts a Diagram 1300 using a data structure for real-time feedback and engagement assessment of the user for measuring dynamic user involvement.

The Diagram 1300 represents an Engagement Assessment System 1302, which is designed to monitor and evaluate student engagement during learning activities. Engagement Assessment System 1302 consists of three main components: Student Profile 1304, Engagement Metrics 1306, and Engagement Score 1308.

The Student Profile 1304 component stores essential information about the student, including the name and engagement score of the student. The engagement score is represented by an instance of the Engagement Score class, which includes the current score of engagement and a timestamp indicating when the score was recorded. The Engagement Metrics 1306 component calculates engagement metrics based on various factors such as interaction intensity and responsiveness. The Engagement Metrics 1306 plays a crucial role in assessing the student's level of engagement accurately. The Engagement Metrics 1306 class includes methods to calculate the engagement score based on the calculated metrics.

The Engagement Assessment System 1302 interacts with both the Student Profile 1304 and Engagement Metrics 1306 components. The Engagement Assessment System 1302 accesses the student's profile to retrieve relevant information and utilizes the engagement metrics to assess the student's engagement level. The Engagement Metrics 1306 component, in turn, interacts with the Engagement Score 1308 class to store and retrieve engagement score data.

The below data structure prepares the diagram 1300 for real-time feedback and engagement assessment of the user for measuring dynamic user involvement:

```
  digraph G {
    node [shape=record];
    EngagementAssessmentSystem [label=“{Engagement
Assessment System|+ studentProfile\n+ engagementMetrics\n+
realTimeFeedback( )}”];
    StudentProfile [label=“{Student Profile|+ name:
string\n+ engagementScore: EngagementScore}”];
    EngagementMetrics [label=“{Engagement Metrics|+
interactionIntensity: float\n+ responsiveness: float\n+
calculateEngagementScore( ): EngagementScore}”];
    EngagementScore [label=“{Engagement Score|+ score:
float\n+ timestamp: datetime}”];
    EngagementAssessmentSystem -> StudentProfile;
    EngagementAssessmentSystem -> EngagementMetrics;
    EngagementMetrics -> EngagementScore;
  }
```

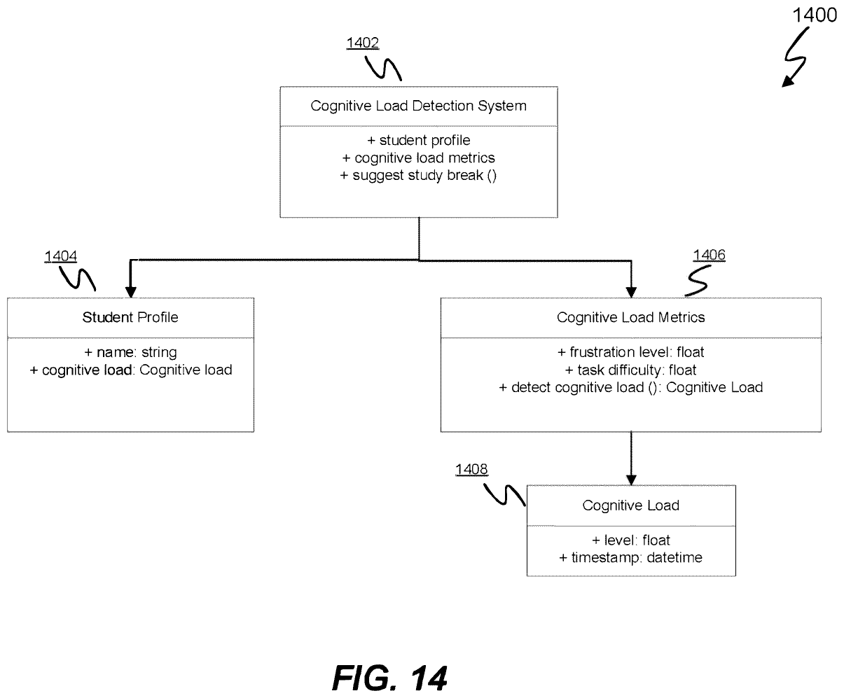

FIG. 14 depicts a diagram 1400 using a data structure to detect cognitive overload and suggest breaks when needed during online sessions.

The Diagram 1400 is designed to support a Cognitive Load Detection System 1402, which aims to monitor and assess students' cognitive load during learning activities. The Cognitive Load Detection System 1402 comprises three main components: Student Profile 1404, Cognitive Load Metrics 1406, and Cognitive Load 1408. The Student Profile 1404 component contains essential information about the student, including the name and cognitive load data of the student. The cognitive load data is represented by an instance of the Cognitive Load class, which includes the current level of cognitive load and a timestamp indicating when the data was recorded.

The Cognitive Load Metrics 1406 component is responsible for calculating cognitive load metrics based on various factors such as frustration level and task difficulty. The Cognitive Load Metrics 1406 are crucial for assessing the student's cognitive load state accurately. The Cognitive Load Metrics 1406 class includes methods to detect cognitive load levels based on the calculated metrics. The Cognitive Load Detection System 1402 interacts with both the Student Profile 1404 and Cognitive Load Metrics 1406 components. The Cognitive Load Detection System 1402 accesses the student's profile to retrieve relevant information and utilizes the cognitive load metrics to assess the student's cognitive load state. The Cognitive Load Metrics 1406 component, in turn, interacts with the Cognitive Load 1408 class to store and retrieve cognitive load data.

The below data structure prepares the diagram 1400 to detect cognitive overload and suggest breaks when needed during online sessions:

```
  digraph G {
    node [shape=record];
    CognitiveLoadDetectionSystem [label=“{Cognitive Load
Detection System|+ studentProfile\n+ cognitiveLoadMetrics\n+
suggestStudyBreak( )}”];
    StudentProfile [label=“{Student Profile|+ name:
string\n+ cognitiveLoad: CognitiveLoad}”];
    CognitiveLoadMetrics [label=“{Cognitive Load Metrics|+
frustrationLevel: float\n+ taskDifficulty: float\n+
detectCognitiveLoad( ): CognitiveLoad}”];
    CognitiveLoad [label=“{Cognitive Load|+ level: float\n+
timestamp: datetime}”];
    CognitiveLoadDetectionSystem -> StudentProfile;
    CognitiveLoadDetectionSystem -> CognitiveLoadMetrics;
    CognitiveLoadMetrics -> CognitiveLoad;
  }
```

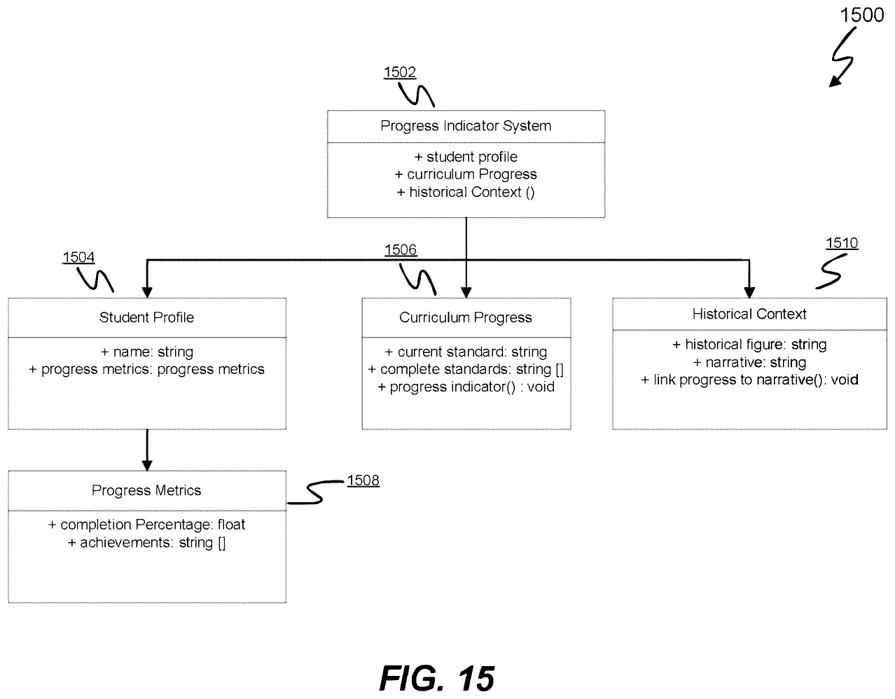

FIG. 15 depicts a diagram 1500 using a data structure to provide the curriculum progress of the user using an indicator linked to the specific figure.

The Diagram 1500 represents a Progress Indicator System 1502, which is designed to track and visualize student's progress within a curriculum, while also providing historical context related to the learning material. The Progress Indicator System 1502 comprises four main components: Student Profile 1504, Curriculum Progress 1506, Progress Metrics 1508, and Historical Context 1510.

The Student Profile 1502 component stores essential information about the student, including the name and progress metrics of the student. The Curriculum Progress 1506 component tracks the student's progress through the curriculum. The Curriculum Progress 1506 includes fields for the current standard being studied, a list of completed standards, and a method to update progress indicators. This information enables the real-time tutor generation system 100 using Artificial Intelligence for adaptive learning to monitor the student's advancement and determine the current standing of the student within the curriculum.

The Progress Metrics 1508 includes measures such as completion percentage and a list of achievements, offering insights into the student's advancement through the curriculum. The Progress Metrics 1508 component provides a detailed overview of the student's progress. The Progress Metrics 1508 includes metrics such as completion percentage and a list of achievements, offering a comprehensive understanding of the student's accomplishments within the curriculum. The Historical Context 1510 component enriches the learning experience by providing historical context related to the curriculum. The Historical Context 1510 includes details such as the historical figure being studied, a narrative associated with the figure, and a method to link progress within the curriculum to the narrative. This historical context helps students understand the significance of the material they are studying and its relevance in a broader historical context.

The Progress Indicator System 1502 interacts with the Student Profile 1504, Curriculum Progress 1506, and Historical Context 1510 components to gather relevant information about the student's progress and provide historical context related to the curriculum. The Student Profile component 1504, in turn, connects to Progress Metrics 1508 to provide detailed insights into the student's progress and achievements.

The below data structure prepares the diagram 1500 to provide the curriculum progress of the user using an indicator linked to the specific figure:

```
  digraph G {
    node [shape=record];
    ProgressIndicatorSystem [label=“{Progress Indicator
System|+ studentProfile\n+ curriculumProgress\n+
historicalContext( )}”];
    StudentProfile [label=“{ Student Profile|+ name:
string\n+ progressMetrics: ProgressMetrics}”];
    CurriculumProgress [label=“{Curriculum Progress|+
currentStandard: string\n+ completedStandards: string[ ]\n+
progressIndicator( ): void}”];
    ProgressMetrics [label=“{Progress Metrics|+
completionPercentage: float\n+ achievements: string[ ]}”];
    HistoricalContext [label=“{Historical Context|+
historicalFigure: string\n+ narrative: string\n+
linkProgressToNarrative( ): void}”];
    ProgressIndicatorSystem -> StudentProfile;
    ProgressIndicatorSystem -> CurriculumProgress;
    StudentProfile -> ProgressMetrics;
    ProgressIndicatorSystem -> HistoricalContext;
  }
```

In another embodiment, the real-time tutor generation system 100 using Artificial Intelligence for adaptive learning involves the Large Language Module (LLM) utilizing retrieval augmented generation to incorporate information from provided sources into the generated response. This process starts with retrieving relevant information from primary 138 and secondary 140 sources based on the input received. The retrieved information is then processed to identify pertinent data and concepts, which are integrated into the generated content. Natural language processing techniques are employed to understand and process the retrieved information, ensuring its accurate integration into the response. Additionally, the incorporation of retrieved information is dynamically adjusted based on user preferences, ensuring personalized responses. Feedback mechanisms are also utilized to continuously improve the retrieval augmented generation process, enhancing the quality and relevance of generated responses over time.

In yet another embodiment, the real-time tutor generation system 100 using Artificial Intelligence for adaptive learning utilizes a vector store to enhance information retrieval. This involves integrating the vector store into the virtual character, allowing for efficient access to stored information during user interactions. When receiving text inputs, they are converted into numerical representations using an embedding engine, which is a pre-trained AI engine 144 operatively coupled in the vector store. These numerical embeddings are indexed and stored within the vector store, facilitating quick retrieval based on relevance to the user input. By utilizing a vector store, the real-time tutor generation system 100 using Artificial Intelligence for adaptive learning can efficiently manage and retrieve information, enhancing the responsiveness and effectiveness of the virtual character in providing relevant and timely information during user interactions.

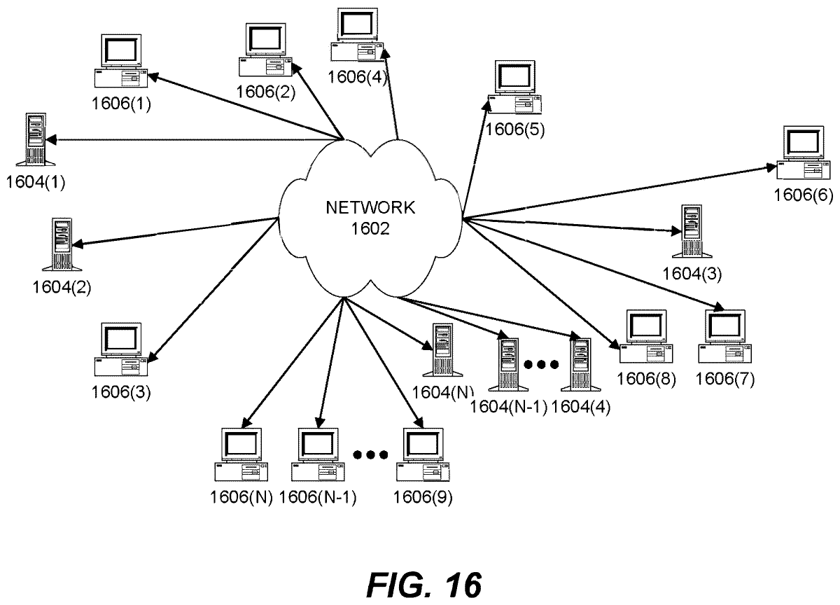

FIG. 16 is a block diagram illustrating a network environment in which a real-time tutor generation system 100 and process 200 using Artificial Intelligence for adaptive learning may be practiced. Network 1602 (e.g. a private wide area network (WAN) or the Internet) includes several networked server computer systems 1604(1)-(N) that are accessible by client computer systems 1606(1)-(N), where N is the number of server computer systems connected to the network. Communication between client computer systems 1606(1)-(N) and server computer systems 1604(1)-(N) typically occurs over a network, such as a public switched telephone network over asynchronous digital subscriber line (ADSL) telephone lines or high-bandwidth trunks, for example, communications channels providing T1 or OC3 service. Client computer systems 1606(1)-(N) typically access server computer systems 1604(1)-(N) through a service provider, such as an internet service provider (“ISP”) by executing application-specific software, commonly referred to as a browser, on one of client computer systems 1606(1)-(N).

Client computer systems 1606(1)-(N) and server computer systems 1604(1)-(N) are specialized computers programmed to improve conventional computer systems to implement and utilize the real-time tutor generation system 100 and process 200 using Artificial Intelligence for adaptive learning. The type of computer system that can be specially programmed to implement and utilize the real-time tutor generation system 100 and process 200 using Artificial Intelligence for adaptive learning includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the real-time tutor generation system 100 and process 200 using Artificial Intelligence for adaptive learning can be implemented using code stored in a tangible, non-transient computer-readable medium and executed by one or more processors. In at least one embodiment, the real-time tutor generation system 100 and process 200 using Artificial Intelligence for adaptive learning can be implemented completely in hardware using, for example, logic circuits and other circuits including field programmable gate arrays.

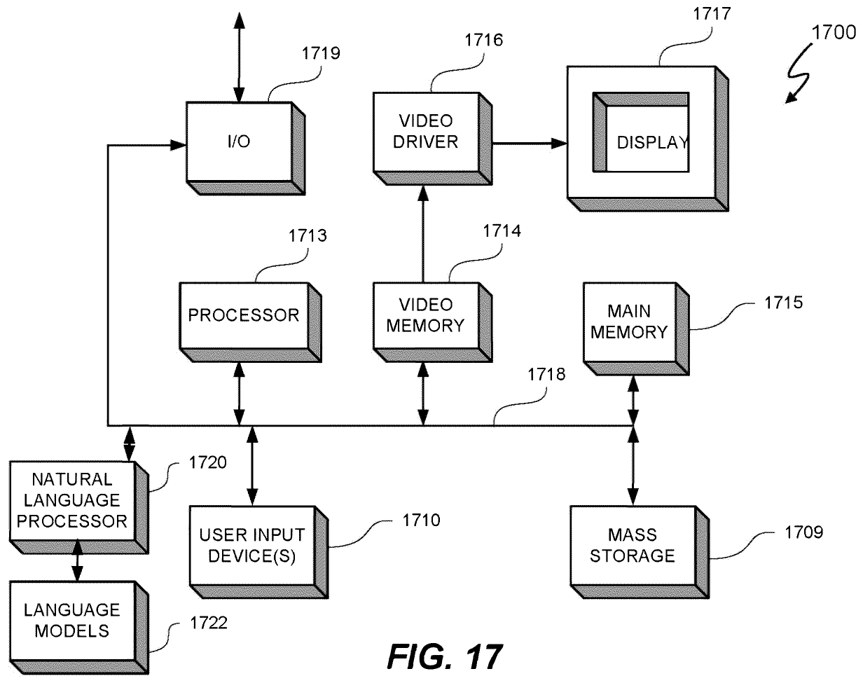

Embodiments of the real-time tutor generation system 100 and process 200 using Artificial Intelligence for adaptive learning can be implemented on a computer system such as a special-purpose, special-programmed computer 1700 illustrated in FIG. 17. Input user device(s) 1710, such as a keyboard and/or mouse, are coupled to a bi-directional system bus 1718. The input user device(s) 1710 are for introducing user input to the computer system and communicating that user input to processor 1713. The computer system of FIG. 17 generally also includes a non-transitory video memory Y14, non-transitory main memory 1715, and non-transitory mass storage 1709, all coupled to bi-directional system bus 1718 along with input user device(s) 1710 and processor 1713. The mass storage 1709 may include fixed and removable media, such as a hard drive, one or more CDs or DVDs, solid state memory including flash memory, and other available mass storage technology. Bus 1718 may contain, for example, 32 of 64 address lines for addressing video memory 1714 or main memory 1715. The system bus 1718 also includes, for example, an n-bit data bus for transferring DATA between and among the components, such as CPU 1709, main memory 1715, video memory 1714, and mass storage 1709, where “n” is, for example, 32 or 64. Alternatively, multiplex data/address lines may be used instead of separate data and address lines.

I/O device(s) 1719 may provide connections to peripheral devices, such as a printer, and may also provide a direct connection to a remote server computer systems via a telephone link or to the Internet via an ISP. I/O device(s) 1719 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 1709, into main memory 1715 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1713, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1715 is comprised of dynamic random access memory (DRAM). Video memory 1714 is a dual-ported video random access memory. One port of the video memory 1714 is coupled to the video amplifier 1716. The video amplifier 1716 is used to drive the display 1717. Video amplifier 1716 is well known in the art and may be implemented by any suitable means. This circuitry converts pixel DATA stored in video memory 1714 to a raster signal suitable for use by display 1717. Display 1717 is a type of monitor suitable for displaying graphic images.

The computer system described above is for purposes of example only. The real-time tutor generation system 100 and process 200 using Artificial Intelligence for adaptive learning may be implemented in any type of computer system programming or processing environment. It is contemplated that the real-time tutor generation system 100 and process 200 using Artificial Intelligence for adaptive learning might be run on a stand-alone computer system, such as the one described above. The real-time tutor generation system 100 and process 200 using Artificial Intelligence for adaptive learning might also be run from a server computer systems system that can be accessed by a plurality of client computer systems interconnected over an intranet network. Finally, the real-time tutor generation system 100 and process 200 using Artificial Intelligence for adaptive learning may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method of guiding an artificial intelligence (AI) engine to generate a virtual character for providing an adaptive and personalized learning to a user, the method comprises:
executing codes using one or more processors of a computer system to cause the computer system to operate comprising:
accessing the virtual character from a virtual characters library having a plurality of virtual characters and initializing communication between the user and the virtual character by receiving real-time speech input from the user, wherein the user speech input is converted to text using a speech-to-text layer;
generating a prompt to guide the AI engine for providing adaptive and personalized learning to the user using the virtual character by providing the converted text to a LLM, wherein the LLM is pre-trained and configured to match the behavior and speech patterns of the specific figure, including historical, fictional, animation, and cartoon characters;
sending the guiding prompt to the AI engine, wherein the guiding prompt shared with the AI engine is generated by analyzing user input to determine the user's learning needs, preferences, or areas requiring assistance, thereby guiding the AI engine to provide relevant and personalized responses;
receiving a video of the virtual character speaking the generated audio response from the AI engine, wherein the generated video is used for adaptive and personalized learning of the user by integrating the video with the selected virtual character.

2. The method of claim 1 wherein the virtual characters are displayed on a user interface of an online learning platform and offer an initial greeting message to the user upon initialization of the communication, the greeting message being contextually relevant to the information provided by the online learning platform.

3. The method of claim 1 wherein the speech input is received from the user in real- time while initializing communication with the virtual character via a microphone or voice input device in the user's device.

4. The method of claim 1 wherein the speech-to-text layer utilizes machine learning algorithms to accurately transcribe the spoken input and natural language processing techniques to improve transcription accuracy.

5. The method of claim 1 further comprises:
i.generating a response to the text input using a Large Language module (LLM) by analyzing the provided text input;
ii.converting the generated response into audio using a text-to-speech converter;

6. The method of claim 1 wherein the text-to-speech converter utilizes neural network-based techniques for generating natural-sounding speech.

7. The method of claim 1 wherein the text-to-speech converter utilizes a diffusion module for audio synthesis comprises:
i. receiving the generated response from the pre-trained LLM;
ii. employing the diffusion module within the text-to-speech converter for synthesis;
iii. conditioning the diffusion model on linguistic features extracted from the generated response text;
iv. modulating the diffusion model to control the clarity and naturalness of the synthesized speech.

8. The method of claim 1 wherein the AI engine is configured to:
i. animate the virtual character's facial movements and lip-syncing based on the generated audio response;
ii. incorporate visual cues to enhance realism, such as eye movements and gestures.

9. The method of claim 1 further comprises:
providing primary and secondary sources about the specific figure to the large language module for context and response generation, wherein the primary sources include authentic documents, recordings, or artifacts directly associated with the specific figure and secondary sources include scholarly works, historical accounts, biographies, and analyses related to the specific figure.

10. The method of claim 1 wherein incorporating information from primary and secondary sources into a generated response comprises:
i. extracting keywords and phrases from the input provided by the user;
ii. searching the primary and secondary resources using keywords and phrases to gather information;
iii. generating a response by a large language module (LLM) initially about the primary and secondary source;

11. The method of claim 1 wherein reviewing and refining a generated response using information from primary and secondary resources comprises:
i. generating an initial response using a LLM without reference to the primary and secondary resources;
ii. reviewing the initial response in correspondence to the primary and secondary resources to ensure consistency and accuracy;
iii. identifying specific keywords and phrases from the initial response to create search terms for retrieving relevant information from the primary and secondary resources;
iv. searching the primary and secondary resources using keywords and phrases to gather additional information;
v. modifying the initial response by adding the retrieved information to ensure accuracy and consistency

12. The method of claim 1 wherein the large language module uses retrieval augmented generation to incorporate information from the provided sources into the generated response further comprises:
i. retrieving relevant information from the primary and secondary sources based on the input received;
ii. processing the retrieved information to identify data and concepts;
iii. generating a response using identified data and concepts and integrating them into the generated content;
iv. employing natural language processing techniques to understand and process the retrieved information, ensuring accurate integration into the generated response;
v. dynamically adjusting the incorporation of retrieved information based on user preferences, ensuring personalized responses;
vi. utilizing feedback mechanisms to continuously improve the retrieval augmented generation process, enhancing the quality and relevance of generated reactions over time.

13. The method of claim 1 utilizes a vector store to enhance information retrieval further comprises:
i. integrating the vector store into the virtual character, allowing for efficient access to stored information during user interactions;
ii. receiving text inputs and converting them into numerical representations using an embedding engine operatively coupled in the vector store, wherein the embedding engine is a pre-trained AI module;
iii. indexing numerical embeddings and storing them within the vector store facilitating quick retrieval based on relevance to user input;

14. The method of claim 1 suggests breaks between the sessions triggered by cognitive load detection comprises:
i. monitoring performance and behavioral indicators of the users during online sessions, wherein the behavior includes eye movements, facial expressions, and typing patterns to infer cognitive load and stress;
ii. detecting cognitive load and stress level in the user using stress detection algorithms and biometric sensors;
iii. analyzing performance metrics such as accuracy, response time, and task completion rates to assess cognitive load;
iv. scheduling breaks based on detected cognitive load and stress levels to optimize learning efficiency and mental well-being, wherein the frequency and duration of breaks can be adjusted to maximize the efficiency of the learning;
v. notifying users through auditory and visual cues.

15. The method of claim 1 wherein the user progress linked to the specific FIG. comprises:
i. tracking the user's progress throughout the online session;
ii. integrating historical narratives with the user's progress using a mapping algorithm;
iii. mapping curriculum topics and learning objectives to corresponding historical events, figures, or concepts;
iv. generating progress indicators linked to specific figures, events, or concepts to provide contextual relevance to the curriculum;
v. analyzing user progress data and historical narratives to identify correlations and connections between curriculum progress and specific figures;
vi. displaying progress indicators and historical narratives to users.

16. The method of claim 1 further comprises:
i. receiving context data of a user's browsing activity, wherein the context data includes the content of the web page currently open in the user's browser, click activity, and keystrokes;
ii. passing the received context data to a LLM operating in a browser-based environment;
iii. utilizing the LLM to generate a response based on the received context data, wherein the response is generated in correspondence to the content of the web page being viewed by the user;
iv. delivering the generated response to the user using the virtual character, thereby providing assistance or answering questions related to the content being browsed by the user.

17. The method of claim 1 further comprises:
streaming the real-time video as a response from the virtual character in the user interface of the online learning platform to receive immediate feedback from the user using a feedback module.

18. A system to guide an artificial intelligence (AI) engine to generate a virtual character to provide an adaptive and personalized learning to a user, the method comprises:
one or more processors;
one or more databases, operatively coupled to the one or more processors that when executed cause the one or more processors to perform operations comprising:
accessing the virtual character from a virtual characters library having a plurality of virtual characters via a user interface integrated within an online learning platform and initializing communication using a communication initialization module between the user and the virtual character by receiving real-time speech input from the user, wherein the user speech input is converted to text using a speech-to-text converter;
generating a prompt using a prompt generator to guide the AI engine for providing adaptive and personalized learning to the user using the virtual character by providing the converted text to a LLM, wherein the LLM is pre-trained and configured to match the behavior and speech patterns of the specific figure, including historical, fictional, animation, and cartoon characters;
sending the guiding prompt to the AI engine, wherein the guiding prompt shared with the AI engine is generated by analyzing user input to determine the user's learning needs, preferences, or areas requiring assistance, thereby guiding the AI engine to provide relevant and personalized responses;
receiving a video of the virtual character speaking the generated audio response generated from the AI engine, wherein the generated video is used for adaptive and personalized learning of the user by integrating the video with the selected virtual character.

19. The system of claim 18 wherein the virtual characters are selected based on the user preferences further comprises:
i. the user interface to present virtual character options to the user;
ii. a selector to allow users to select virtual characters from the plurality of virtual characters based on their preferences;
iii. a recommendation module to recommend virtual characters based on the user's learning history, preferences, or current learning tasks.

20. The system of claim 18 wherein the virtual characters offer personalized learning recommendations based on user preferences and learning history.

21. The system of claim 18 wherein the AI engine generates responses in correspondence to the user's learning style, pace, or level of understanding, thereby adapting the learning experience to the individual needs of the user.

22. The system of claim 18 wherein the communication initialization module between the user and the virtual character further comprises:
providing context data to the virtual character, including user profile information, learning history, or current learning objectives.

23. The system of claim 18 further comprises a video streaming module to stream the real-time video as a response from the virtual character in the user interface of the online learning platform to receive immediate feedback from the user using a feedback module.

24. The system of claim 18 wherein the virtual characters exhibit behavior and speech patterns consistent with their specific figures further comprises:
i. matches the user behavior to ensure that the behavior and speech patterns of the virtual characters match those of their specific figures;
ii. a database to store behavior and speech pattern data for each virtual character;
iii. compares the user input and responses with the expected behavior and speech patterns of the selected virtual character.

25. The system of claim 18 wherein the virtual characters employ emotion recognition to enhance interaction further comprises:
i. analyzing emotion using facial expressions, tone of voice, and other biometric signals;
ii. detecting emotion using emotions such as happiness, frustration, confusion, or stress;
iii. adjusting the response of the virtual character based on the emotions of the user.

26. The system of claim 18 wherein the virtual characters adapt their responses based on user feedback to improve engagement and learning outcomes.
